(19) United States
(12) Patent Application Publication
(10) Pub. No.: US 2023/0080619 A1
(43) Pub. Date: Mar. 16, 2023

(54) HEATER ELEMENT WITH FUNCTIONAL MATERIAL CONTAINING LAYER, HEATER UNIT WITH FUNCTIONAL MATERIAL CONTAINING LAYER, VEHICLE INTERIOR PURIFICATION SYSTEM AND HONEYCOMB STRUCTURE

(71) Applicant: NGK Insulators, Ltd., Nagoya-City (JP)

(72) Inventors: Yukio MIYAIRI, Nagoya-City (JP); Masaaki MASUDA, Nagoya-City (JP); Koji KUZUTANI, Konan-City (JP); Shuichi ICHIKAWA, Nagoya-City (JP); Toru HAYASE, Nagoya-City (JP); Hirofumi YAMAGUCHI, Nagoya-City (JP); Narimasa SHINODA, Ichinomiya-City (JP); Takahiko NAKATANI, Kani-City (JP)

(73) Assignee: NGK Insulators, Ltd., Nagoya-City (JP)

(21) Appl. No.: 18/057,340

(22) Filed: Nov. 21, 2022

Related U.S. Application Data
(63) Continuation of application No. PCT/JP2022/023010, filed on Jun. 7, 2022.

(30) Foreign Application Priority Data
Jun. 18, 2021 (JP) 2021-101992

(51) Int. Cl. B60H 3/06; B60H 1/00; H05B 3/24; B01D 53/04; B01D 53/88; B01J 20/16; B01J 20/28; B01J 35/04

(52) U.S. Cl. CPC B60H 3/0608; B60H 1/00835; H05B 3/24; B01D 53/0438; B01D 53/885; B01J 20/16; B01J 20/28045; B01J 35/04; B60H 2003/0691; H05B 3/14

(57) ABSTRACT

A heater element with a functional material-containing layer includes: a honeycomb structure including an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property; a pair of electrodes provided on the first end face and the second end face of the honeycomb structure; and a functional material-containing layer provided on a surface of the partition walls.

### FIELD OF THE INVENTION

The present invention relates to a heater element with a functional material-containing layer, a heater unit with a functional material-containing layer, a vehicle interior purification system, and a honeycomb structure.

### BACKGROUND OF THE INVENTION

In various types of vehicles such as automobiles, there are increasing requirements for improvement of vehicle interior environment. Specific requirements include reduction of an amount of CO₂ in the vehicle interior to suppress driver's drowsiness, and removal of harmful volatile components such as odor components and allergy-causing components in the vehicle interior. Ventilation is the most effective measure for such requirements, but the ventilation causes a large loss of heater energy in winter, leading to deterioration of energy efficiency in winter. In particular, a battery electric vehicle (BEV) has a problem that its cruising range is significantly reduced due to its energy loss.

As a method for solving the above problem, Patent Literature 1 discloses a vehicle interior purification system in which components to be removed such as CO₂ in the air in the vehicle interior are trapped by a functional material such as an adsorbent, and the components to be removed are then allowed to react or desorbed by heating to discharge them to the outside of the vehicle. Such a vehicle interior purification system requires more contact between the air and the functional material in order to ensure the performance of trapping the components to be removed, and the ability of the functional material to be heated to a predetermined temperature in order to facilitate the release of the trapped components to be removed from the functional material.

On the other hand, Patent Literature 2 discloses a heater element, including: a pillar shaped honeycomb structure portion having an outer peripheral wall and partition walls disposed on an inner side of the outer peripheral wall and defining a plurality of cells forming flow paths from a first end face to a second end face, wherein the partition walls have a PTC property, the partition walls have an average thickness of 0.13 mm or less, and the first and second end faces have an opening ratio of 0.81 or more. The heater element is used as a heater for heating the vehicle interior.

### PRIOR ART

### Patent Literatures

[Patent Literature 1] Japanese Patent Application Publication No. 2020-104774 A
[Patent Literature 2] WO 2020/036067 A1

### SUMMARY OF THE INVENTION

The heater element described in Patent Literature 2 is used for heating the vehicle interior, and it is also considered to be useful as a support for supporting a functional material. In particular, the heater element described in Patent Literature 2 can be heated by electrical conduction and has the PTC property. Therefore, it can easily heat the functional material, while it would be able to suppress heating to an excessive temperature and suppress thermal degradation of the functional material.

However, as a result of studies, the present inventors have found that when the functional material is applied to the heater element described in Patent Literature 2, the cells of the pillar shaped honeycomb structure are clogged with the functional material, and the opening ratio of the cells on which the functional material is supported is excessively decreased. In such a state, the contact between the air and the functional material is hindered, and the pressure loss increases when the air passes through the cells, resulting in problems such as an inability to ensure the flow rate of the air. Therefore, the heater element described in Patent Literature 2 cannot be suitable for use in applications that utilize the function of the functional material, and there is still room for improvement.

The present invention has been made to solve the above problems. An object of the present invention is to provide a heater element with a functional material-containing layer, a heater unit with a functional material-containing layer, and a vehicle interior purification system, which can sufficiently utilize the functions of the functional material.

Another object of the present invention is to provide a honeycomb structure suitable for producing the heater element with a functional material-containing layer as described above.

The above problems are solved by the present invention as described below, and the present invention is as follows:

[1]

A heater element with a functional material-containing layer, the heater element comprising:

a honeycomb structure comprising an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property;

a pair of electrodes provided on the first end face and the second end face of the honeycomb structure; and

a functional material-containing layer provided on a surface of the partition walls.

[2]

The heater element with a functional material-containing layer according to [1], wherein the honeycomb structure has a thickness of the partition walls of 0.10 to 0.36 mm, a cell density of 15.5 to 100 cells/cm², and an opening ratio of the cells of 70 to 94%.

[3]

The heater element with a functional material-containing layer according to [2], wherein the honeycomb structure has a thickness of the partition walls of 0.14 to 0.36 mm, a cell density of 15.5 to 46.5 cells/cm², and an opening ratio of the cells of 80 to 94%.

[4]

The heater element with a functional material-containing layer according to any one of [1] to [3], wherein the functional material-containing layer has a thickness of 20 to 400 μm.

[5]

The heater element with a functional material-containing layer according to any one of [1] to [4], wherein the functional material-containing layer comprises an adsorbent.

[6]

The heater element with a functional material-containing layer according to [5], wherein the adsorbent comprises an aluminosilicate as a main component.

[7]

The heater element with a functional material-containing layer according to any one of [1] to [6], wherein the functional material-containing layer comprises a catalyst.

[8]

The heater element with a functional material-containing layer according to any one of [1] to [7], wherein the honeycomb structure has a length of 2 to 20 mm in a flow path direction and a cross-sectional area of 10 cm² or more, the cross-sectional area being orthogonal to the flow path direction.

[9]

The heater element with a functional material-containing layer according to any one of [1] to [8], wherein the material having the PTC property comprises barium titanate as a main component, has a Curie point of 100 to 250° C., and is made of a material that is substantially free of lead.

A heater unit with a functional material-containing layer, comprising two or more of the heater elements with a functional material-containing layer according to any one of [1] to [9].

A vehicle interior purification system, comprising:

the heater element with the functional material-containing layer according to any one of [1] to [9], or a heater unit with a functional material-containing layer comprising two or more of the heater elements with the functional material-containing layer;

a battery for applying a voltage to the heater element with the functional material-containing layer or the heater unit with the functional material-containing layer;

an inflow pipe that communicates between a vehicle interior and an inflow port of the heater element with the functional material-containing layer or the heater unit with the functional material-containing layer;

an outflow pipe that communicates between an outflow port of the heater element with the functional material-containing layer or the heater unit with the functional material-containing layer, and the vehicle interior and a vehicle exterior; and

a switching valve provided in the outflow pipe, the switching valve being capable of switching a flow of air flowing through the outflow pipe to the vehicle interior or the vehicle exterior.

The vehicle interior purification system according to [11], comprising a control unit for alternately executing:

a first mode wherein components to be removed, which are contained in air from the vehicle interior, are trapped in the functional material-containing layer of the heater element with the material-containing layer or the heater unit with the functional material-containing layer by turning off the voltage applied from the battery and switching the switching valve such that the flow of air flowing through the outflow pipe is directed to the vehicle interior; and

a second mode wherein the components to be removed, which have been trapped in the functional material containing layer, are discharged to the vehicle exterior by turning on the voltage applied from the battery and switching the switching valve such that the flow of air flowing through the outflow pipe is directed to the vehicle exterior.

A honeycomb structure used for a heater element with a functional material-containing layer, the honeycomb structure comprising:

an outer peripheral wall and partition walls disposed on an inner side of the outer peripheral wall, the partition walls defining a plurality of cells to form flow paths extending from a first end face to a second end face, wherein at least the partition walls are made of a material having a PTC property, a thickness of the partition walls is 0.10 to 0.36 mm, a cell density is 15.5 to 100 cells/cm², and an opening ratio of the cells is 70 to 94%.

According to the present invention, it is possible to provide a heater element with a functional material-containing layer, a heater unit with a functional material-containing layer, and a vehicle interior purification system, which can sufficiently utilize the functions of the functional material.

Also, according to the present invention, it is possible to provide a honeycomb structure suitable for producing the heater element with a functional material-containing layer as described above.

### BRIEF DESCRIPTION OF THE DRAWINGS

FIG. 1 is a schematic view of an end face of a heater element according to an embodiment of the invention;

FIG. 2 is a schematic view of a cross section of a heater element according to an embodiment of the present invention, which is parallel to a flow path direction;

FIG. 3 is a schematic front view of a heater unit according to an embodiment of the present invention, as viewed from a first end face side; and

FIG. 4 is a schematic view illustrating an arrangement example of a vehicle interior purification system according to an embodiment of the present invention.

### DETAILED DESCRIPTION OF THE INVENTION

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

(1. Heater Element with Functional Material-Containing Layer)

A heater element with a functional material-containing layer (hereinafter, abbreviated as a “heater element”) according to an embodiment of the present invention can be suitably utilized as a heater element for use in a vehicle interior purification system for various vehicles such as automobiles. The vehicle includes, but not limited to, automobiles and trains. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The heater element according to the embodiment of the present invention can be particularly suitably used for a vehicle having no internal combustion engine such as electric vehicles and electric railcars.

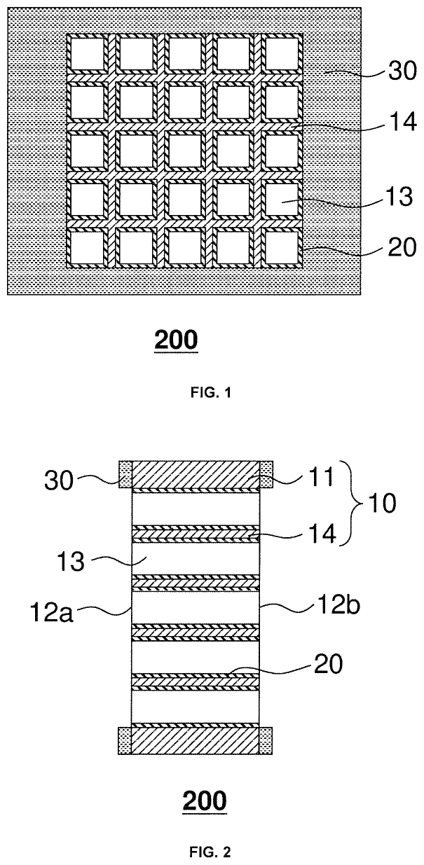

FIG. 1 is a schematic view of an end face of a heater element according to an embodiment of the invention. FIG. 2 is a schematic view of a cross section of a heater element according to an embodiment of the present invention, which is parallel to a flow path direction.

As shown in FIGS. 1 and 2, a heater element 200 includes: a honeycomb structure 10 having an outer peripheral wall 11 and partition walls 14 disposed on an inner side of the outer peripheral wall 11 and defining a plurality of cells 13 to form flow paths extending from a first end face 12a to a second end face 12b; a pair of electrodes 30 provided on the first end face 12a and the second end face 12b of the honeycomb structure 10; and a functional material-containing layer 20 provided on the surface of the partition walls 14. Moreover, at least the partition walls 14 are made of a material having a PTC property. With such a configuration, an in-plane temperature difference of the honeycomb structure 10 (a temperature difference in the cross section of the honeycomb structure 10 perpendicular to the flow path direction) can be reduced, and the functional material-containing layer 20 can be uniformly heated, so that the function of the functional material-containing layer 20 can be fully utilized.

Each member forming the heater element 200 will be described below in detail.

### (1-1. Honeycomb Structure 10)

The shape of the honeycomb structure 10 is not particularly limited. As the shape of the honeycomb structure 10, for example, a cross section (outer shape) perpendicular to the flow path direction (the extending direction of the cells 13) can be polygonal (quadrangular (rectangular, square), pentagonal, hexagonal, heptagonal, octagonal, etc.), circular, oval (egg-shaped, elliptical, elliptic, rounded rectangular, etc.), and the like. The end faces (first end face 12a and second end face 12b) have the same shape as the cross section. Also, when the cross section and the end faces are polygonal, the corners may be chamfered.

The shape of each cell 13 is not particularly limited, but it may be polygonal (quadrangular, pentagonal, hexagonal, heptagonal, octagonal, etc.), circular, or oval in the cross section perpendicular to the flow path direction. These shapes may be alone or in combination of two or more. Moreover, among these shapes, the quadrangle or the hexagon is preferable. By providing the cells 13 having such a shape, it is possible to reduce the pressure loss when the air flows. FIGS. 1 and 2 show, as an example, a honeycomb structure 10 in which the cross section (outer diameter) and the shape of each cell 13 are quadrangular in the cross section orthogonal to the flow path direction.

The honeycomb structure 10 may be a honeycomb joined body having a plurality of honeycomb segments and joining layers that join the plurality of honeycomb segments together. The use of the honeycomb joined body can increase the total cross-sectional area of the cells 13, which is important for ensuring the flow rate of air, while suppressing cracking.

It should be noted that the joining layer can be formed by using a joining material. The joining material is not particularly limited, but a ceramic material obtained by adding a solvent such as water to form a paste can be used. The joining material may contain ceramics having a PTC property, or may contain the same ceramics as the outer peripheral wall 11 and the partition walls 14. In addition to the role of joining the honeycomb segments to each other, the joining material can also be used as an outer peripheral coating material after joining the honeycomb segments.

Although the thickness of the partition walls 14 is not particularly limited, it is preferably determined based on the following viewpoints. First, from the viewpoint of ensuring the strength of the honeycomb structure 10, the thickness of the partition walls 14 is preferably 0.10 mm or more, and more preferably 0.12 mm or more, and still more preferably 0.14 mm or more, and even more preferably 15 mm or more, and particularly preferably 0.20 mm or more. However, if the partition walls 14 is too thick, the pressure loss when the air passes through the cells 13 may increase. Therefore, from the viewpoint of suppressing an increase in pressure loss, the thickness of the partition walls 14 in the honeycomb structure 10 is preferably 0.36 mm or less, and more preferably 0.35 mm or less, and even more preferably 0.30 mm or less.

It should be noted that the thickness of the partition walls 14 refers to a length of a line segment that crosses the partition walls 14 when connecting the centers of gravity of adjacent cells 13 with the line segment in the cross section orthogonal to the flow path direction. The thickness of the partition walls 14 refers to an average thickness of all the partition walls 14.

Although the thickness of the outer peripheral wall 11 is not particularly limited, it is preferably determined based on the following viewpoints. First, from the viewpoint of reinforcing the honeycomb structure 10, the thickness of the outer peripheral wall 11 is preferably 0.05 mm or more, and more preferably 0.06 mm or more, and even more preferably 0.08 mm or more. On the other hand, the thickness of the outer peripheral wall 11 is preferably 1.0 mm or less, and more preferably 0.5 mm, and more preferably 0.4 mm or less, and still more preferably 0.3 mm or less, from the viewpoint of suppressing the initial current by increasing the electrical resistance and from the viewpoint of reducing pressure loss when air flows.

The thickness of the outer peripheral wall 11 refers to a length from a boundary between the outer peripheral wall 11 and the outermost cell 13 or partition wall 14 to a side surface of the honeycomb structure 10 in a normal line direction of the side surface in the cross section orthogonal to the flow path direction.

Although the cell density of the honeycomb structure 10 is not particularly limited, it is preferably determined based on the following viewpoints. First, from the viewpoint of preventing clogging while supporting the functional material as much possible, the cell density of the honeycomb structure 10 is preferably 100 cells/cm² or less, and more preferably 46.5 cells/cm² or less, and still more preferably 45.0 cells/cm² or less, and particularly preferably 43.0 cells/cm² or less. However, if the cell density is too low, the contact area with air may be insufficient. Therefore, from the viewpoint of ensuring a sufficient contact area with air, the cell density of the honeycomb structure 10 is preferably 15.5 cells/cm² or more, and more preferably 18.0 cells/cm² or more, and still more preferably 20.0 cells/cm² or more.

As used herein, the cell density of the honeycomb structure 10 is a value obtained by dividing the number of cells by the area of each end face of the honeycomb structure 10.

Although the opening ratio of the cells 13 of the honeycomb structure 10 is not particularly limited, it is preferably determined based on the following viewpoints. First, from the viewpoint of maximizing the supported amount of the functional material, the opening ratio of the cells 13 of the honeycomb structure 10 is preferably 70% or more, and more preferably 80% or more, and still more preferably 83% or more, and particularly preferably 85% or more. However, if the opening ratio of the cells 13 is too large, the strength of the honeycomb structure 10 may decrease. Therefore, from the viewpoint of ensuring the strength of the honeycomb structure 10, the opening ratio of the cells 13 of the honeycomb structure 10 is preferably 94% or less, and more preferably 92% or less, and even more preferably 90% or less.

The opening ratio of the honeycomb structure 10 is a value expressed in a percentage, obtained by dividing the area of the cells 13 by the area of the entire cross section (total area of the outer peripheral wall 11, the partition walls 14 and the cells 13) in the cross section of the honeycomb structure 10 perpendicular to the flow path direction.

The length of the honeycomb structure 10 in the flow path direction and the cross-sectional area perpendicular to the flow path direction may be adjusted according to the required size of the heater element 200, and are not particularly limited. For example, when used in a compact heater element 200 while ensuring a predetermined function, the honeycomb structure 10 can have a length of 2 to 20 mm in the flow path direction and a cross-sectional area of 10 cm² or more perpendicular to the flow path direction. Although the upper limit of the cross-sectional area perpendicular to the flow path direction is not particularly limited, it is, for example, 300 cm².

The partition wall 14 forming the honeycomb structure 10 is made of a material having a PTC (Positive Temperature Coefficient) property. Further, the outer peripheral wall 11 may also be made of the material having the PTC property, as with the partition wall 14, as needed.

The material having the PTC property is a material that can generate heat by electrical conduction. The functional material-containing layer 20 can be heated by heat transfer from the heat-generating outer peripheral wall 11 and partition wall 14. Further, the material having the PTC property has characteristics such that when the temperature increases and exceeds the Curie point, the resistance value is sharply increased, resulting in a difficult for electricity to flow. Therefore, when the temperature of the heater element 200 becomes high, the partition wall 14 (or the outer peripheral wall 11 if necessary) limits the current flowing through them, thereby suppressing excessive heat generation of the heater element 200. Therefore, it is possible to suppress thermal deterioration of the functional material-containing layer 20 due to excessive heat generation.

The material having the PTC property is not particularly limited, but materials containing barium titanate (BaTiO₃) as a main component are preferable, and materials containing barium titanate (BaTiO₃)-based crystals as a main component in which a part of Ba is substituted with a rare earth element are more preferable. As used herein, the term “main component” means a component in which a proportion of the component is more than 50% by mass of the total component. The content of BaTiO₃-based crystalline particles can be determined by, for example, fluorescent X-ray analysis, EDAX (energy dispersive X-ray) analysis, or the like. Other crystalline particles can also be measured by the same method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er and Yb, and more preferably La. The x value is preferably 0.001 or more, and more preferably 0.0015 or more, and even more preferably 0.002 or more, in terms of suppressing excessively high electrical resistance at room temperature. On the other hand, x is preferably 0.001 or less, and more preferably 0.009 or less, and even more preferably 0.002 or less, in terms of preventing the electrical resistance at room temperature from becoming too high due to insufficient sintering.

The BaTiO₃-based crystalline particles in which a part of Ba is substituted with the rare earth element preferably have a (Ba+rare earth element)/Ti ratio of from 1.005 to 1.050. By controlling the (Ba+rare earth element)/Ti ratio to such a range, the electrical resistance at room temperature can be stably reduced. The element ratio of Ba, the rare earth element, and Ti can be determined by, for example, X-ray fluorescence analysis and ICP-MS (inductively coupled plasma mass spectrometry).

The BaTiO₃-based crystalline particles in which a part of Ba is substituted with the rare earth element preferably have an average crystal grain size of from 5 to 200 μm, and more preferably from 5 to 180 μm, and even more preferably from 5 to 160 μm. By controlling the average crystal grain size to such a range, the electrical resistance at room temperature can be stably reduced.

The average crystal grain size of the BaTiO₃-based crystalline particles can be measured as follows. A square sample having 5 mm×5 mm×5 mm is cut out from the ceramics and encapsulated with a resin. The encapsulated sample is mirror-polished by mechanical polishing and observed by SEM. The SEM observation is carried out using, for example, a model S-3400N from Hitachi High-Tech Corporation, at an acceleration voltage of 15 kV and at magnifications of 3000. In the SEM observation image (30 μm in length×45 μm in width), four straight lines each having a thickness of 0.3 μm were drawn at intervals of 10 μm across the entire vertical direction of the field of view, and the number of BaTiO₃-based crystalline particles through which these lines pass even at a part of them is counted. An average of the SEM images at four or more positions where the length of the straight line is divided by the number of BaTiO₃-based crystalline particles is defined as the average crystal grain size.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by, for example, fluorescent X-ray analysis or EDAX (energy dispersive X-ray) analysis. Other crystalline particles can be measured in the same manner as this method.

The ceramics used for the outer peripheral wall 11 and the partition walls 14 preferably contains Ba₆Ti₁₇O₄₀ crystalline particles. The presence of Ba₆Ti₁₇O₄₀ crystalline particles in the ceramics can reduce the electrical resistance at room temperature. Although not wishing to be bound by any theory, it is believed that Ba₆Ti₁₇O₄₀ crystalline particles are liquefied during a firing process to promote rearrangement, grain growth and densification of BaTIO₃-based crystalline particles, thus reducing the electrical resistance at room temperature.

The content of the Ba₆Ti₁₇O₄₀ crystalline particles in the ceramics may be from 1.0 to 10.0% by mass, and preferably from 1.2 to 8.0% by mass, and even more preferably from 1.5 to 6.0% by mass. The content of the Ba₆Ti₁₇O₄₀ crystalline particles of 1.0% by mass or more can provide an effect of the presence of the Ba₆Ti₁₇O₄₀ crystalline particles (i.e., an effect of reducing the electric resistance at room temperature). Further, the content of the Ba₆Ti₁₇O₄₀ crystalline particles of 10.0% by mass or less can ensure the PTC property.

The ceramics used for the outer peripheral wall 11 and the partition walls 14 can further contain BaCO₃ crystalline particles. The BaCO₃ crystalline particles are those derived from BaCO₃ powder, which is a raw material for the ceramics.

The BaCO₃ crystalline particles may not be contained in the ceramics because they have substantially no effect on the electrical resistance of the ceramics at room temperature. However, if the content of BaCO₃ crystalline particles in the ceramics is too high, it may affect the electrical resistance at room temperature, and the number of other crystalline particles may decrease, so that desired properties may not be obtained. Therefore, the content of the BaCO₃ crystalline particles is preferably 2.0% by mass or less, and more preferably 1.8% by mass or less, and further preferably 1.5% by mass or less. The lower limit of the content of BaCO₃ crystalline particles is not particularly limited, but it may generally be 0.1% by mass, and preferably 0.2% by mass.

The ceramics used for the outer peripheral wall 11 and the partition walls 14 may further contain a component(s) conventionally added to PTC materials, in addition to the above crystalline particles. Such a component includes additives such as shifters, property improving agents, metal oxides and conductor powder, as well as unavoidable impurities.

In terms of reduction of the environmental load, it is desirable that the ceramics used for the outer peripheral wall 11 and the partition walls 14 is substantially free of lead (Pb). More particularly, the ceramics preferably has a Pb content of 0.01% by mass or less, and more preferably 0.001% by mass or less, and still more preferably 0% by mass. The lower Pb content can allow heated air to be safely applied to organisms such as humans by contacting the ceramics, for example. In the ceramics, the Pb content is preferably less than 0.03% by mass, and more preferably less than 0.01% by mass, and further preferably 0% by mass, as converted to PbO. The lead content can be determined by, for example, fluorescent X-ray analysis, ICP-MS (inductively coupled plasma mass spectrometry), or the like.

It is preferable that the ceramics used for the outer peripheral wall 11 and the partition walls 14 is substantially free of an alkali metal which may affect the electric resistance at room temperature. More particularly, the ceramics preferably has an alkali metal content of 0.01% by mass or less, and more preferably 0.001% by mass or less, and still more preferably 0% by mass. By controlling the content of the alkali metal to such a range, the electrical resistance at room temperature can be stably reduced. The alkali metal content can be determined by, for example, fluorescent X-ray analysis, ICP-MS (inductively coupled plasma mass spectrometry), or the like.

The material making up the outer peripheral wall 11 and the partition walls 14 preferably have a Curie point of 100° C. or more, and more preferably 110° C. or more, and even more preferably 125° C. or more, in terms of efficiently heating the air. Further, the upper limit of the Curie point is preferably 250° C., and preferably 225° C., and even more preferably 200° C., and still more preferably 150° C., in terms of safety as a component placed in the vehicle interior or near the vehicle interior.

The Curie point of the material making up the outer peripheral wall 11 and the partition walls 14 can be adjusted by the type of shifter and an amount of the shifter added. For example, the Curie point of barium titanate (BaTiO₃) is about 120° C., but the Curie point can be shifted to the lower temperature side by substituting a part of Ba and Ti with one or more of Sr, Sn and Zr.

In the present invention, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YHP). Based on an electrical resistance-temperature plot obtained by the measurement, a temperature at which the resistance value is twice the resistance value at room temperature (20° C.) is defined as the Curie point.

### (1-2. Functional Material-Containing Layer 20)

The functional material-containing layer 20 is provided on the surfaces of the partition walls 14 of the honeycomb structure 10. Specifically, the functional material-containing layer 20 is provided on the surfaces of the partition walls 14 and the outer peripheral wall 11 facing the cells 13 of the honeycomb structure 10.

The functional material-containing layer 20 provided on the partition walls 14 of the honeycomb structure 10 is indirectly heated by the heat of the honeycomb structure 10 heated by the pair of electrodes 30. Therefore, to exert sufficiently the function of the functional material-containing layer 20, it is important to reduce the in-plane temperature difference (in-plane temperature distribution) of the honeycomb structure 10 so that the temperature of the entire functional material-containing layer 20 is uniformly increased to the activation temperature. In fact, when the in-plane temperature difference of the honeycomb structure 10 is larger, a sufficiently increased temperature of the low-temperature portion may result in an excessive temperature of the high-temperature portion, so that a part of the functional material-containing layer 20 may be deteriorated. If there is such a partially deteriorated region of the functional material-containing layer 20, the function of the functional material-containing layer 20 cannot be completely utilized.

In an embodiment of the present invention, the pair of electrodes 30 are provided on the first end face 12a and the second end face 12b of the honeycomb structure 10, and the partition walls 14 are made of the material having the PTC property, so that the electrical resistance is higher at a high temperature, and the electrical resistance is lower at a low temperature. Therefore, when a voltage is applied to the pair of electrodes 30, the current preferentially flows in the low-temperature portion of the honeycomb structure 10 and the in-plane temperature difference can be reduced, and as a result, the entire functional material-containing layer 20 can be uniformly heated to the activation temperature.

Further, the control of the thickness of the partition walls 14 of the honeycomb structure 10, the cell density and the opening ratio of the cells 13 can prevent the cells 13 of the honeycomb structure from being clogged or the opening area of the cells 13 from becoming too small, even if the functional material-containing layer 20 is provided. Therefore, sufficient contact between the functional material-containing layer 20 and air can be ensured, so that the function of the functional material can be stably obtained, and an increase in pressure loss upon air passing through the cells 13 can be suppressed.

The thickness of the functional material-containing layer 20 may be determined according to the size of the cells 13, and is not particularly limited. For example, the thickness of the functional material-containing layer 20 is preferably 20 μm or more, and more preferably 25 μm or more, and even more preferably 30 μm or more, from the viewpoint of ensuring sufficient contact with air. On the other hand, the thickness of the functional material-containing layer 20 is preferably 400 μm or less, and more preferably 380 μm or less, and even more preferably 350 μm or less, from the viewpoint of suppressing separation of the functional material-containing layer 20 from the partition walls 14 and the outer peripheral wall 11.

It should be noted that the thickness of the functional material-containing layer 20 refers to the shortest length between the partition wall 14 provided with the functional material-containing layer 20 and the cell 13 in the cross section orthogonal to the flow path direction.

The functional material contained in the functional material-containing layer 20 that can be used herein includes, but not particularly limited to, adsorbents, catalysts, and the like.

In one embodiment, the functional material-containing layer 20 preferably contains the adsorbent. By containing the adsorbent, components to be removed such as CO₂ and harmful volatile components in the air in the vehicle interior can be trapped.

In another embodiment, the functional material-containing layer 20 preferably contains the catalyst. By using a catalyst, the components to be removed can be purified. For the purpose of enhancing the ability of the adsorbent to trap components to be removed, the adsorbent and the catalyst may be used together.

The adsorbent preferably has a function that can adsorb the components to be removed, such as CO₂ and harmful volatile components (e.g., aldehydes, odor components, etc.) at −20 to 40° C. and release them at an elevated temperature of 60° C. or more. Examples of the adsorbent having such functions include materials mainly based on aluminosilicates (e.g., zeolite), silica gel, activated carbon, alumina, silica, low-crystalline clay, amorphous aluminum silicate complexes, and the like. The type of the adsorbent may be appropriately selected depending on the types of the components to be removed.

The catalyst preferably has a function capable of promoting the oxidation-reduction reaction. The catalysts having such functions include metal catalysts such as Pt, Pd and Ag, and oxide catalysts such as CeO₂ and ZrO₂.

The harmful volatile components contained in the air in the vehicle interior include, for example, volatile organic compounds (VOC) and odor components. Specific examples of the harmful volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, fenobcarb and the like. In addition to CO₂ and the harmful volatile components, the components to be removed include moisture and the like.

### (1-3. Electrode 30)

The pair of electrodes 30 are provided on the first end face 12a and the second end face 12b of the honeycomb structure 10. In FIGS. 1 and 2, the pair of electrodes 30 are provided on the surface of the outer peripheral wall 11, but they may be provided on the surface of the partition wall 14 in addition to the surface of the outer peripheral wall 11. By applying a voltage in a direction parallel to the flow path direction of the honeycomb structure 10 by the pair of electrodes 30, the heat can be generated in the honeycomb structure 10 by Joule heat.

Further, each of the electrodes 30 may have an extending portion extending toward the outside of the honeycomb structure 10. The provision of the extending portion can facilitate connection with a connector that is in charge of connection with the outside.

Each of the electrodes 30 may employ, for example, a metal or alloy containing at least one selected from Cu, Ag, Al, Ni and Si, although not particularly limited thereto. It is also possible to use an ohmic electrode capable of ohmic contact with the outer peripheral wall 11 and/or the partition walls 14 which have the PTC property. The ohmic electrode may employ an ohmic electrode containing, for example, at least one selected from Au, Ag and In as a base metal, and containing at least one selected from Ni, Si, Ge, Sn, Se and Te for n-type semiconductors as a dopant. Further, the electrode 30 may have a single-layer structure, or may have a laminated structure of two or more layers. When the electrode 30 has the laminated structure of two or more layers, the materials of each layer may be of the same type or of different types.

The thickness of each electrode 30 is not particularly limited, and it may be appropriately set according to the method for forming the electrode 30. The method for forming the electrodes 30 includes metal deposition methods such as sputtering, vapor deposition, electrolytic deposition, and chemical deposition. Alternatively, the electrode 30 can be formed by applying an electrode paste and then baking it, or by thermal spraying. Furthermore, the electrode 30 may be formed by joining metal or alloy plates.

It is preferable that the thickness of each electrode 30 is about 5 to 80 μm for baking the electrode paste, and about 100 to 1000 nm for dry plating such as sputtering and vapor deposition, and about 10 to 100 μm for thermal spraying, and about 5 μm to 50 μm for wet plating such as electrolytic deposition and chemical deposition. Further, when joining the metal or alloy plates, the thickness of the electrode 30 is preferably about 5 to 100 μm.

### (1-4. Method for Producing Heater Element 200)

Next, a method for producing a heater element 200 according to an embodiment of the invention will be exemplified.

When the material of the honeycomb structure 10 is ceramics, a method for producing the honeycomb structure 10 includes a forming step and a firing step.

In the forming step, a green body containing a ceramic raw material including BaCO₃ powder, TiO₂ powder, and rare earth nitrate or hydroxide powder is formed to prepare a honeycomb formed body.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the honeycomb formed body is 60%.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extrude the green body. In the extrusion, a die having a desired overall shape, cell shape, partition wall thickness, cell density and the like can be used.

The relative density of the honeycomb formed body obtained by extrusion is 60% or more, and preferably 61% or more. By controlling the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes a step of maintaining the ceramic formed body at a temperature of from 1150 to 1250° C., and then increasing the temperature to a maximum temperature of from 1360 to 1430° C. at a heating rate of 20 to 500° C./hour, and maintaining the temperature for 0.5 to 5 hours.

The maintaining of the honeycomb formed body at the maximum temperature of from 1360 to 1430° C. for 0.5 to 5 hours can provide the honeycomb structure 10 mainly based on BaTiO₃-based crystal particles in which a part of Ba is substituted with the rare earth element.

Further, the maintaining at the temperature of from 1150 to 1250° C. can allow the Ba₂TiO₄ crystal particles generated in the firing step to be easily removed, so that the honeycomb structure 10 can be densified.

Further, the heating rate of 20 to 500° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 10.

The retention time at 1150 to 1250° C. is not particularly limited, but it may preferably be from 0.5 to 5 hours. Such a retention time can lead stable and easy removal of Ba₂TiO₄ crystal particles generated in the firing step.

The firing step preferably includes, prior to the above step, a step of maintaining at 900 to 950° C. for 0.5 to 5 hours. The maintaining at 900 to 950° C. for 0.5 to 5 hours can lead to sufficient decomposition of BaCO₃, so that the honeycomb structure 10 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of controlling electrical characteristics and production cost.

A firing furnace used in the firing step and the degreasing step is not particularly limited, but it may be an electric furnace, a gas furnace, or the like.

The functional material-containing layer 20 is formed on the partition walls 14 of the honeycomb structure 10 thus obtained.

The method for forming the functional material-containing layer 20 is not particularly limited, but, for example, the honeycomb structure 10 may be immersed in a slurry containing the functional material, an organic binder, and water, and excess slurry on the end faces and the outer circumference of the honeycomb structure 10 is removed by blowing and wiping. Subsequently, the functional material-containing layer 20 can be formed on the partition walls 14 by drying at a temperature of about 550° C. Although this step may be performed once, it is possible to provide the partition walls 14 with the functional material-containing layer 20 having a desired thickness by repeating that step several times.

The pair of electrodes 30 are then formed on the first end face 12a and the second end face 12b of the honeycomb structure 10 on which the functional material-containing layer 20 is formed. The pair of electrodes 30 may be a single layer, or may be a plurality of layers with different compositions. It should be noted that the pair of electrodes 30 may be formed before the functional material-containing layer 20 is formed.

### (1-5. Method for Using Heater Element 200)

The heater element 200 according to an embodiment of the present invention can trap the components to be removed such as CO₂ and harmful volatile components by passing air containing the components to be removed through the cells 13 at −20 to 40° C., preferably at room temperature.

The heater element 200 according to the embodiment of the present invention can heat the honeycomb structure 10 by heating from the outside. Moreover, the heater element 200 according to the embodiment of the present invention can heat the honeycomb structure 10 by applying a voltage through the pair of electrodes 30. From the viewpoint of rapid heating, the applied voltage is preferably 200 V or more, and more preferably 250 V or more. By causing the honeycomb structure 10 to generate heat, the trapped components to be removed can be released from the functional material-containing layer 20 and removed to the outside. The heat generation temperature of the honeycomb structure 10 may be appropriately set depending on the types of the functional materials, and is, for example, 60 to 150° C.

(2. Heater Unit with Functional Material-Containing Layer)

A heater unit with a functional material-containing layer (hereinafter abbreviated as “heater unit”) according to an embodiment of the present invention can be suitably used as a heater unit used in a vehicle interior purification system for various vehicles such as automobiles. The heater unit according to the embodiment of the present invention includes two or more heater elements 200. By using two or more heater elements 200 having improved functions of the functional material (in particular, the function of trapping the components to be removed and the function of releasing the trapped components to be removed during heating), the function of the functional material (in particular, the function of the vehicle interior purification performance) can be enhanced. Further, since the heater element 200 can be made compact, it is possible to suppress an increase in the size of the heater unit.

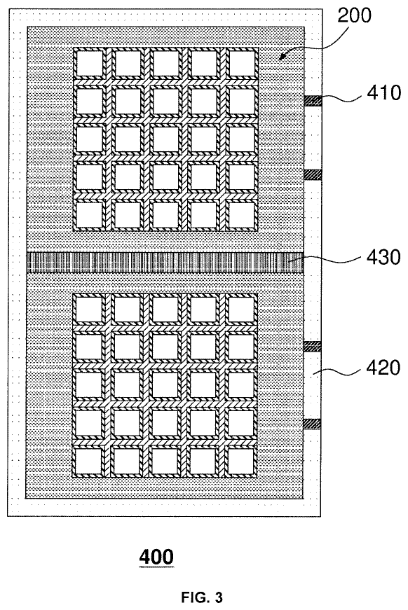

FIG. 3 is a schematic front view of a heater unit including two heater elements 200, as viewed from the first end face side of the heater elements.

As shown in FIG. 3, the heater unit 400 according to the embodiment of the invention includes two heater elements 200. Moreover, in this heater unit 400, the heater elements 200 are stacked and arranged such that the side surfaces parallel to the flow path direction of the honeycomb structure 10 face each other.

Each electrode 30 of the heater element 200 is provided with a terminal 410 that can be connected to an external power source. The terminal 410 is preferably connected to the surface of the extending portion of the electrode 30 on the honeycomb structure 10 side. Such a structure can allow the heater element 200 to be made compact. The method for connecting the electrode 30 to the terminal 410 is not particularly limited as long as they are electrically connected, and they can be connected by, for example, diffusion bonding, mechanical pressure mechanism, welding, or the like.

The terminal 410 may be made of, for example, a metal, although not limited thereto. The metal that can be used herein includes a single metal, an alloy, and the like. In terms of corrosion resistance, electrical resistance, and linear expansion rate, for example, the metal may preferably be an alloy containing at least one selected from the group consisting of Cr, Fe, Co, Ni, Cu, and Ti, and more preferably stainless steel, Fe—Ni alloys, and phosphorus bronze.

The stacked heater elements 200 are housed in a housing (housing member) 420.

The material of the housing 420 includes, but not particularly limited to, metals, resins, and the like. Among them, it is preferable that the material of the housing 420 is the resin. By using the housing 420 made of the resin, electric shock can be suppressed without grounding.

An insulating material 430 may be placed between the heater elements 200 stacked and arranged. Such a structure can allow electrical short circuit between the plurality of heater elements 200 to be suppressed.

The insulating material 430 that can be used herein includes a plate material, a mat, a cloth, or the like made of an insulating material such as alumina or ceramics.

### (3. Vehicle Interior Purification System)

The vehicle interior purification system according to the present invention can be suitably used as a vehicle interior purification system for various vehicles such as automobiles. Especially, in the vehicle interior purification system according to the embodiment of the present invention, the heater element 200 or heater unit 400 having improved functions of the functional material (in particular, the function of trapping the components to be removed and the function of releasing the trapped components to be removed during heating) is used, so that the vehicle interior purification performance of the vehicle interior purification system can be improved.

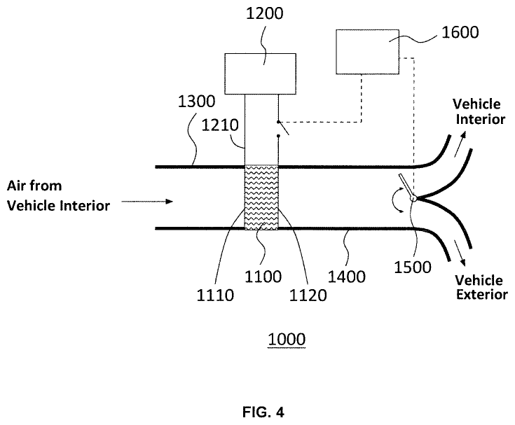

FIG. 4 is a schematic view illustrating an arrangement example of a vehicle interior purification system according to an embodiment of the present invention.

As shown in FIG. 4, a vehicle interior purification system 1000 includes: the heater element or heater unit 1100 as described above; a battery (power source) 1200 for applying a voltage to the heater element or heater unit 1100; an inflow pipe 1300 that communicates between a vehicle interior and an inflow port 1110 of the heater element or heater unit 1100; an outflow pipe 1400 that communicates between an outflow port 1120 of the heater element or heater unit 1100 and the vehicle interior and a vehicle exterior; and a switching valve 1500 provided in the outflow pipe 1400, the switching valve 1500 being capable of switching a flow of air flowing through the outflow pipe 1400 to the vehicle interior or the vehicle exterior.

The heater element or heater unit 1100 can be configured, for example, to be connected to the battery 1200 by an electric wire 1210 and turn on a power switch on the way to conduct a current through the heater element or heater unit 1100 to generate heat.

The on-off switching of the power switch can be performed by a control unit 1600 electrically connected to the power switch. The switching of the switching valve 1500 can also be performed by the control unit 1600 electrically connected to the switching valve 1500.

In the vehicle interior purification system 1000 having the structure as described above, air from the vehicle interior passes through the inflow pipe 1300 and is fed from the inflow port 1110 to the heater element or heater unit 1100. After the air is subjected to predetermined processing by the heater element or heater unit 1100 according to instructions from the control unit 1600, the air is discharged from the outflow port 1120 and returned to the vehicle interior or discharged to the vehicle exterior through the outflow pipe 1400. Examples of the predetermined process include a process of alternately executing a first mode and a second mode.

In the first mode, the voltage applied from the battery 1200 is turned off, and the switching valve 1500 is switched so that the flow of the air flowing through the outflow pipe 1400 can be directed to the vehicle interior, thereby trapping the components to be removed contained in the air from the vehicle interior in the functional material-containing layer 20 of the heater element or heater unit 1100.

In the second mode, the voltage applied from the battery 1200 is turned on, and the switching valve 1500 is switched so that the flow of the air flowing through the outflow pipe 1400 is directed to the vehicle exterior, thereby discharging the components to be removed to the vehicle exterior.

By repeating on/off of the applied voltage and switching of the switching valve 1500 as described above in a constant cycle, it is possible to stably discharge the component to be removed from the vehicle interior to the vehicle exterior.

In the purification system 1000, the heater element or the heater unit 1100 is preferably arranged at a position close to the vehicle interior, in terms of stably ensuring the above functions. Therefore, from the viewpoint of preventing electric shock, the drive voltage is preferably 60 V or less. Since the honeycomb structure 10 used in the heater element or the heater unit 1100 has lower electrical resistance at room temperature, the honeycomb structure 10 can be heated at the lower drive voltage. The lower limit of the drive voltage is not particularly limited, but it may preferably be 10 V or more. If the drive voltage is less than 10 V, the current during heating of the honeycomb structure 10 is increased, so that the electric wire 1210 must be thickened.

### Examples

Hereinafter, the present invention will be described in more detail with reference to Examples, but the present invention is not limited to these Examples.

### <Experiment 1>

As ceramic raw materials, BaCO₃ powder, TiO₂ powder and La(NO₃)₃.6H₂O powder were prepared. These powders were weighed so as to have the predetermined composition after firing, and dry-mixed to obtain a mixed powder. The dry mixing was carried out for 30 minutes. Subsequently, from 3 to 30 parts by weight of water, a binder, a plasticizer and a dispersant in total were added by a proper amount, based on 100 parts by mass of the obtained mixed powder, such that aceramic formed body having a relative density of 64.8% were obtained after extrusion, and then kneaded to obtain a green body. Methyl cellulose was used as the binder. Polyoxyalkylene alkyl ether was used as the plasticizer and the dispersant.

The obtained green body was then introduced into an extrusion molding machine and extruded using a predetermined die to obtain a honeycomb formed body having the shape as shown below after the firing.

Shape of the cross section and each end face of the honeycomb formed body orthogonal to flow path direction: quadrangular;
Shape of each cell perpendicular to the flow direction: quadrangular;
Thickness of partition wall: 0.14 mm;
Thickness of outer peripheral wall: 0.4 mm;
Cell density: 100 cells/cm²;
Opening ratio of the cells: 73.9%;
Size of the cross section orthogonal to the flow path direction of the honeycomb formed body: 30 mm×30 mm;
Length of the honeycomb formed body in the flow path direction: 30 mm; and
Curie point of the material forming the outer peripheral wall and the partition walls: 120° C.

Subsequently, after dielectric drying and hot air drying of the obtained honeycomb formed body, it was degreased in an air atmosphere in a firing furnace (450° C.×4 hours), and then fired in an air atmosphere to obtain a honeycomb structure. The firing was carried out by maintaining it at 950° C. for 1 hour, and then increasing the temperature to 1200° C. and maintaining it at 1200° C. for 1 hour, and then increasing the temperature at a temperature increasing rate of 200° C./hour to 1400° C. (the maximum temperature) and maintaining it at 1400° C. for 2 hours.

Subsequently, an Al—Ni electrode paste and an Ag electrode paste were sequentially applied to both end faces (the first end face and the second end face) of the obtained honeycomb structures (the number of samples was 5), and then baked at 700° C. to form electrodes each having a two-layer structure (Al—Ni electrode layer having 10 μm+Ag electrode layer having 30 μm) (A-1 to A-5).

For comparison, two kinds of electrode pastes were sequentially applied in the same manner as described above to the opposing side surfaces (opposing outer peripheral surfaces parallel to the flow path direction) of the obtained honeycomb structures (the number of samples was 5) and then baked to form electrodes each having a two-layer structure (Al—Ni electrode layer having 10 μm+Ag electrode layer having 30 μm) (B-1 to B-5).

The honeycomb structure on which the electrodes were formed was then immersed in a slurry containing zeolite (functional material), an organic binder and water, and excess slurry on the end faces and outer circumference was then removed by blowing and wiping, and then dried at a temperature of about 550° C. to form a functional material-containing layer having a thickness of 0.2 mm on the partition walls.

Subsequently, the in-plane temperature difference was evaluated for each sample of the heater element with the functional material-containing layer obtained as described above. The in-plane temperature difference was determined by applying a voltage of 48 V between a pair of electrodes for heating, and measuring the temperatures at four corner portions and one central portion of the outlet end face by a thermocouple while flowing air at an average wind speed of 0.1 m/sec in the cells of the honeycomb structure. Then, the maximum value of the temperature difference between each corner portion and the center portion was determined as the in-plane temperature difference. If the in-plane temperature difference is 20° C. or less, it can be evaluated that the whole can be uniformly heated to the activation temperature without degrading the functional material-containing layer. The results are shown in Table 1.

TABLE 1

| | | In-Plane Temperature | |
|---|---|---|---|
| | Electrode | Difference | |
| No. | Position | (° C.) | Classification |
| A-1 | End Face | 13 | Example |
| A-2 | End Face | 15 | Example |
| A-3 | End Face | 12 | Example |
| A-4 | End Face | 18 | Example |
| A-5 | End Face | 15 | Example |
| B-1 | Side Surface | 55 | Comparative Example |
| B-2 | Side Surface | 60 | Comparative Example |
| B-3 | Side Surface | 58 | Comparative Example |
| B-4 | Side Surface | 63 | Comparative Example |
| B-5 | Side Surface | 70 | Comparative Example |

As shown in Table 1, it was found that the heater element with a functional material-containing layer (Examples) having the pair of electrodes provided on both end faces of the honeycomb structure had a reduced in-plane temperature difference and could uniformly heat the entire functional material-containing layer, as compared with the heater element with the functional material (Comparative Examples) having the pair of electrodes provided on the opposing side surfaces of the honeycomb structure.

### <Experiment 2>

A green body prepared in the same manner as that of Experiment 1 was introduced into an extruder, and extruded using a predetermined die so as to form a honeycomb formed body having the shape as shown in Table 2 after firing. Table 2 shows the results of evaluation of the extrusion molding by visual observation. In this evaluation, A indicates that the formability was good, B indicates that the cells were deformed, and C indicates that the cells were crushed and could not be formed into the desired honeycomb shape. If the formability is A or B in this evaluation, it can be evaluated that the functional material-containing layer can be provided on the surface of the partition wall.

Other conditions regarding the honeycomb formed body were as follows:

Shape of the cross section and each end face of the honeycomb formed body orthogonal to flow path direction: quadrangular;
Shape of each cell perpendicular to the flow direction: quadrangular;
Thickness of outer peripheral wall: 0.4 mm;
Size of the cross section orthogonal to the flow path direction of the honeycomb formed body: 35 mm×35 mm;
Length of the honeycomb formed body in the flow path direction: 10 mm; and Curie point of the material forming the outer peripheral wall and the partition walls: 120° C.

Subsequently, after dielectric drying and hot air drying of the obtained honeycomb formed body, it was degreased in an air atmosphere in a firing furnace (450° C.×4 hours), and then fired in an air atmosphere to obtain a honeycomb structure. The firing was carried out by maintaining it at 950° C. for 1 hour, and then increasing the temperature to 1200° C. and maintaining it at 1200° C. for 1 hour, and then increasing the temperature at a temperature increasing rate of 200° C./hour to 1400° C. (the maximum temperature) and maintaining it at 1400° C. for 2 hours.

The obtained honeycomb structure was then immersed in a slurry containing zeolite (functional material), an organic binder and water, and excess slurry on the end faces and outer circumference was then removed by blowing and wiping, and then dried at a temperature of about 550° C. to form a functional material-containing layer on the partition walls. Each end face of the honeycomb structure having the functional material-containing layer thus formed was visually observed to evaluate the clogging of the cells. Table 2 shows the results. In this evaluation, A indicates that a clogging ratio (number of clogged cells/total number of cells×100) was less than 1%, B indicates that the clogging ratio was 1% or more and 10% or less, and C indicates that the clogging ratio was more than 10% and 15% or less, D indicates that the clogging ratio was more than 15% and 20% or less, and E indicates that the clogging ratio was more than 20%. In addition, this evaluation was not carried out for those whose formability was C (those which could not be formed). In this evaluation, if the clogging ratio is 20% or less, it can be evaluated that the minimum necessary functional material-containing layer can be provided on the surface of the partition wall.

TABLE 2

| | | | Opening | | |
|---|---|---|---|---|---|
| | Thickness of | Cell | Ratio | | |
| | Partition Wall | Density | of Cells | | Clogging |
| No. | (mm) | (cell/cm²) | (%) | Formability | Ratio |
| 1-1 | 0.432 | 15.50 | 68.9 | A | E |
| 1-2 | 0.356 | 15.50 | 74.0 | A | D |
| 1-3 | 0.305 | 15.50 | 77.4 | A | C |
| 1-4 | 0.279 | 15.50 | 79.2 | A | B |
| 1-5 | 0.254 | 15.50 | 81.0 | A | A |
| 1-6 | 0.229 | 15.50 | 82.8 | A | A |
| 1-7 | 0.203 | 15.50 | 84.6 | A | A |
| 1-8 | 0.051 | 15.50 | 96.0 | C | — |
| 2-1 | 0.356 | 23.25 | 68.6 | A | E |
| 2-2 | 0.280 | 23.25 | 74.9 | A | D |
| 2-3 | 0.254 | 23.25 | 77.0 | A | C |
| 2-4 | 0.229 | 23.25 | 79.2 | A | B |
| 2-5 | 0.203 | 23.25 | 81.4 | A | A |
| 2-6 | 0.178 | 23.25 | 83.6 | A | A |
| 2-7 | 0.152 | 23.25 | 85.8 | A | A |
| 2-8 | 0.051 | 23.25 | 95.2 | C | — |
| 3-1 | 0.305 | 31.00 | 68.9 | A | E |
| 3-2 | 0.254 | 31.00 | 73.7 | A | D |
| 3-3 | 0.203 | 31.00 | 78.7 | A | B |
| 3-4 | 0.178 | 31.00 | 81.2 | A | A |
| 3-5 | 0.152 | 31.00 | 83.7 | A | A |
| 3-6 | 0.127 | 31.00 | 86.4 | B | A |
| 3-7 | 0.102 | 31.00 | 89.0 | B | A |
| 3-8 | 0.038 | 31.00 | 95.8 | C | — |
| 4-1 | 0.280 | 38.75 | 68.2 | A | E |
| 4-2 | 0.229 | 38.75 | 73.6 | A | D |
| 4-3 | 0.203 | 38.75 | 76.3 | A | C |
| 4-4 | 0.178 | 38.75 | 79.1 | A | B |
| 4-5 | 0.152 | 38.75 | 81.9 | A | A |
| 4-6 | 0.127 | 38.75 | 84.8 | B | A |
| 4-7 | 0.102 | 38.75 | 87.8 | B | A |
| 4-8 | 0.076 | 38.75 | 90.7 | C | — |
| 5-1 | 0.254 | 46.50 | 68.3 | A | E |
| 5-2 | 0.203 | 46.50 | 74.2 | A | C |
| 5-3 | 0.178 | 46.50 | 77.2 | A | B |
| 5-4 | 0.152 | 46.50 | 80.3 | A | A |
| 5-5 | 0.127 | 46.50 | 83.4 | B | A |
| 5-6 | 0.102 | 46.50 | 86.6 | B | A |
| 5-7 | 0.033 | 46.50 | 95.5 | C | — |
| 6-1 | 0.203 | 100 | 63.5 | A | E |
| 6-2 | 0.140 | 100 | 74.0 | A | D |
| 6-3 | 0.114 | 100 | 78.4 | C | — |
| 6-4 | 0.076 | 100 | 85.3 | C | — |
| 6-5 | 0.025 | 100 | 95.0 | C | — |
| 7-1 | 0.203 | 120 | 74.1 | A | E |
| 7-2 | 0.178 | 120 | 64.8 | A | E |
| 7-3 | 0.076 | 120 | 84.0 | A | E |
| 7-4 | 0.051 | 120 | 89.2 | C | — |

As shown in Table 2, the honeycomb structure having a thickness of the partition wall of 0.10 to 0.36 mm, a cell density of 15.5 to 100 cells/cm², and an opening ratio of the cells of 70 to 94% had good formability, and less clogging of the cells.

On the other hand, honeycomb structures in which any one of the thickness of the partition wall, the cell density, and the opening ratio of the cells was outside the above range had insufficient formability and/or increased clogging of the cells.

As can be seen from the above results, according to the present invention, it is possible to provide a heater element with a functional material-containing layer, a heater unit with a functional material-containing layer, and a vehicle interior purification system, which can sufficiently utilize the functions of the functional material. Also, according to the present invention, it is possible to provide a honeycomb structure suitable for producing the heater element with a functional material-containing layer as described above.

### DESCRIPTION OF REFERENCE NUMERALS

10 honeycomb structure
11 outer peripheral wall
12a first end face
12b second end face
13 cell
14 partition wall
20 functional material-containing layer
30 electrode
200 heater element
400 heater unit
410 terminal
420 housing
430 insulating material
1000 vehicle interior purification system
1100 heater element or heater unit
1110 inflow port
1120 outflow port
1200 battery
1210 electric wire
1300 inflow pipe
1400 outflow pipe
1500 switching valve
1600 control unit

1. A heater element with a functional material-containing layer, the heater element comprising:
a honeycomb structure comprising an outer peripheral wall and partition walls disposed on an inner side of the outer peripheral wall, the partition walls defining a plurality of cells, each of the cells extending from a first end face to a second end face to form a flow path, at least the partition walls being made of a material having a PTC property;
a pair of electrodes provided on the first end face and the second end face of the honeycomb structure; and
a functional material-containing layer provided on a surface of the partition walls;
wherein the honeycomb structure has a thickness of the partition walls of 0.10 to 0.36 mm, a cell density of 15.5 to 100 cells/cm², and an opening ratio of the cells of 70 to 94%, and
the functional material-containing layer has a thickness of 20 to 400 μm.

2. The heater element with a functional material-containing layer according to claim 1, wherein the honeycomb structure has a thickness of the partition walls of 0.14 to 0.36 mm, a cell density of 15.5 to 46.5 cells/cm², and an opening ratio of the cells of 80 to 94%.

3. The heater element with a functional material-containing layer according to claim 1, wherein the functional material-containing layer comprises an adsorbent.

4. The heater element with a functional material-containing layer according to claim 3, wherein the adsorbent comprises an aluminosilicate as a main component.

5. The heater element with a functional material-containing layer according to claim 1, wherein the functional material-containing layer comprises a catalyst.

6. The heater element with a functional material-containing layer according to claim 1, wherein the honeycomb structure has a length of 2 to 20 mm in a flow path direction and a cross-sectional area of 10 cm² or more, the cross-sectional area being orthogonal to the flow path direction.

7. The heater element with a functional material-containing layer according to claim 1, wherein the material having the PTC property comprises barium titanate as a main component, has a Curie point of 100 to 250° C., and is made of a material that is substantially free of lead.

8. A heater unit with a functional material-containing layer, comprising two or more of the heater elements with a functional material-containing layer according to claim 1.

9. A vehicle interior purification system, comprising:
the heater element with the functional material-containing layer according to claim 1, or a heater unit with a functional material-containing layer comprising two or more of the heater elements with the functional material-containing layer;
a battery for applying a voltage to the heater element with the functional material-containing layer or the heater unit with the functional material-containing layer;
an inflow pipe that communicates between a vehicle interior and an inflow port of the heater element with the functional material-containing layer or the heater unit with the functional material-containing layer;
an outflow pipe that communicates between an outflow port of the heater element with the functional material-containing layer or the heater unit with the functional material-containing layer, and the vehicle interior and a vehicle exterior; and
a switching valve provided in the outflow pipe, the switching valve being capable of switching a flow of air flowing through the outflow pipe to the vehicle interior or the vehicle exterior.

10. The vehicle interior purification system according to claim 9, comprising a control unit for alternately executing:
a first mode wherein components to be removed, which are contained in air from the vehicle interior, are trapped in the functional material-containing layer of the heater element with the material-containing layer or the heater unit with the functional material-containing layer by turning off the voltage applied from the battery and switching the switching valve such that the flow of air flowing through the outflow pipe is directed to the vehicle interior; and
a second mode wherein the components to be removed, which have been trapped in the functional material containing layer, are discharged to the vehicle exterior by turning on the voltage applied from the battery and switching the switching valve such that the flow of air flowing through the outflow pipe is directed to the vehicle exterior.

11. A honeycomb structure used for a heater element with a functional material-containing layer, the honeycomb structure comprising:
an outer peripheral wall and partition walls disposed on an inner side of the outer peripheral wall, the partition walls defining a plurality of cells to form flow paths extending from a first end face to a second end face, wherein at least the partition walls are made of a material having a PTC property, a thickness of the partition walls is 0.10 to 0.36 mm, a cell density is 15.5 to 100 cells/cm², and an opening ratio of the cells is 70 to 94%.
